(19) United States
(12) Patent Application Publication
(10) Pub. No.: US 2026/0251776 A1
(43) Pub. Date: Aug. 27, 2026

(54) AN APPARATUS FOR DETERMINING EGO-MOTION

(71) Applicant: NXP B.V., Eindhoven (NL)

(72) Inventors: Simin Zhu, Delft (NL); Olexander Yarovyi, Delft (NL); Francesco Fioranelli, Delft (NL); Satish Ravindran, Fremont, CA (US)

(21) Appl. No.: 19/162,686

(22) PCT Filed: Apr. 21, 2023
(86) PCT No.: PCT/EP2023/060400

§ 371 Date: Sep. 5, 2025

(30) Foreign Application Priority Data
Apr. 21, 2023 (WO) PCT/EP2023/060400

(51) Int. Cl. G01S 13/60; G01S 7/41; G01S 13/931

(52) U.S. Cl. CPC G01S 13/60; G01S 7/417; G01S 13/931

(57) ABSTRACT

The present application relates to an apparatus for determining the ego-motion of a radar apparatus, the apparatus configured to: process radar-point-cloud information comprising a plurality of points by neural network models, the processing comprising: pointwise mapping the features thereof to a greater number of mapped-features to provide mapped-radar-point-cloud information, determining a global feature vector indicative of characteristics of the mapped-radar-point-cloud information, generating a feature matrix wherein each point therein is characterized by a feature-set based on a combination of the features, the mapped-features and the global feature vector, determining a pointwise-weight representing a likelihood that the point represents a stationary object in the space, a pointwise-offset comprising a correction to be applied to the Doppler velocity measurement to at least reduce the Doppler velocity measurement for points having a greater than expected Doppler velocity, and providing an estimate of the motion of the radar apparatus.

### CROSS-REFERENCE TO RELATED APPLICATIONS

This application claims the priority under 35 U.S.C. § 119 of U.S. Provisional application No. 63/488,799 filed Mar. 7, 2023, and PCT patent application no. PCT/EP2023/060400, filed Apr. 21, 2023, the contents of which are incorporated by reference herein.

### FIELD

The present disclosure relates to an apparatus configured to determine ego-motion and, in particular, the ego-motion of a radar apparatus. In particular, it also relates to an apparatus for determination of the ego-motion of a radar apparatus mounted to a mobile platform, such as a vehicle, using information from the radar apparatus. It also relates to an associated method.

### BACKGROUND

Automotive Radar plays an important role in Autonomous Driving (AD) systems and Advanced Drivers Assistance System (ADAS) as a key sensing modality to provide environmental perception capability to enable safe driving functions. A major challenge relates to Ego Motion Estimation. Ego motion estimation in the field of radar relates to the determination of the position and/or velocity of a radar apparatus based on analysis of a radar “image(s)” or point cloud(s) of a space captured by the radar apparatus.

### SUMMARY

According to a first aspect of the present disclosure there is provided an apparatus for determining the ego-motion of a radar apparatus, the apparatus comprising one or more processors configured to:
receive radar-point-cloud information, the radar-point-cloud information comprising a plurality of points determined by the radar apparatus indicative of one or more objects in a space at a single time point, wherein each point of the plurality of points is characterised by a plurality of features comprising at least a Doppler velocity measurement indicative of the velocity of the point and an angle-of-arrival measurement indicative of the angle to the point from a reference direction of the radar apparatus;
provide for processing of the radar-point-cloud information, the processing comprising:
(1) for each point of the radar-point-cloud information, mapping the features thereof to a greater number of mapped-features to provide mapped-radar-point-cloud information using a first neural network comprising a shared-multilayer-perceptron, SMLP, encoder;
(2) receiving the mapped-radar-point-cloud information and, based on thereon, determining a global feature vector indicative of one or more characteristics of the mapped-radar-point-cloud information using a second neural network comprising an average pooling layer;
(3) generating a feature matrix representing each of the points, wherein each point therein is characterized by a feature-set based on a combination of:
   i) the features from the radar-point-cloud information,
   ii) the mapped-features from the mapped-radar-point-cloud information and
   iii) the global feature vector;
(4) determining, using a further neural network, for each point;
   i) a pointwise-weight representing a likelihood that the point represents a stationary object in the space rather than a moving object in the space;
   ii) a pointwise-offset comprising a correction to be applied to the Doppler velocity measurement to at least reduce the Doppler velocity measurement for points having a greater than expected Doppler velocity; and
(5) providing an estimate of the motion of the radar apparatus indicative of at least two-dimensional motion based on the pointwise weight and the pointwise offset and the Doppler velocity measurements of the radar-point-cloud information.

In one or more embodiments, the one or more neural network models are trained based on training data, comprising instances of point-cloud information associated with a respective predetermined, motion value, and a loss function, the loss function comprising a function of:
a) a motion loss function, Lossₘₒₜᵢₒₙ, based on a mean squared error between the estimate of the motion of the radar apparatus and the predetermined, motion value; and
b) a Doppler loss function, Loss_{doppler}, based on a transform of the real, predetermined, motion value to a radial velocity, a Doppler error comprising a difference between the transform of the predetermined, motion value and the Doppler velocity measurements of each instance of the training data, a probability that the Doppler error is expected relative to a sample distribution, and a mean squared error function.

In one or more embodiments, the loss function is further based on:
c) a sample weight function, S, comprising a measure of whether the distribution of the Doppler velocity measurements of each set of the training data is consistent with an expected sample distribution based on the real, predetermined, motion value.

In one or more embodiments, the loss function comprises:
Loss Function=(Lossₘₒₜᵢₒₙ+μ. Loss_{doppler}). S wherein μ is a weighting factor.
wherein μ is a weighting factor.

In one or more embodiments, the processing of the radar-point-cloud information using one or more neural network models comprises processing by a deep neural network.

In one or more embodiments, the average pooling layer is trained to provide a symmetric function configured to aggregate information from all of the points of the mapped-radar-point-cloud information and output the global feature vector indicative of a characteristic of the mapped-radar-point-cloud information.

In one or more embodiments, the generation of the feature matrix is provided by a concatenation element, wherein the concatenation element is configured to duplicate the global feature vector a number of times equal to the number of points and, for each point, a concatenation of the features, the mapped features and one of the duplicated feature vectors is generated, to thereby generate the feature matrix.

In one or more embodiments, the further neural network comprises:
a third neural network comprising a second shared-multilayer-perceptron, SMLP, decoder, configured to, for each point of the feature matrix, map the feature-set to a lesser number of mapped-features, to thereby provide mapped-feature matrix;
a pointwise-weights prediction element configured to, based on the mapped-feature matrix, provide the pointwise weight; and
a pointwise-offset prediction element configured to based on the mapped-feature matrix, provide the pointwise offset.

In one or more embodiments, the pointwise-weights prediction element comprises a neural network configured to operate based on a weighted least squares algorithm and a sigmoid activation function.

In one or more embodiments, the pointwise-weights prediction element comprises a neural network.

In one or more embodiments, the apparatus is configured to determine the estimate of the motion of the radar apparatus, V^{est} based on:

$${V}^{est} = {( {A}^{T} {W}^{est} . A )}^{- 1} {A}^{T} {W}^{est} ( D + {O}^{est} )$$

wherein A comprises a matrix that transforms Doppler velocity measurements to cartesian velocity measurements, A^{T} represents a transpose of matrix A, W^{est} is a matrix of the pointwise weights, O^{est} is a matrix of the pointwise offsets and D is a matrix of the Doppler velocity measurements for each of the points extracted from the radar-point-cloud information.

In one or more embodiments, the apparatus is configured to provide an output identifying one or more objects in the space as comprising one of a stationary object and a moving object based on the pointwise weight and the pointwise offset.

In one or more embodiments, the sample weight function is configured to assign higher importance to the instances of training data that have more points that are consistent with expected Doppler velocity measurements based on the respective predetermined, motion value.

According to a second aspect of the present disclosure there is provided a method for determining the ego-motion of a radar apparatus, the method performed by one or more processors and comprising:
receiving radar-point-cloud information, the radar-point-cloud information comprising a plurality of points determined by the radar apparatus indicative of one or more objects in a space at a single time point, wherein each point of the plurality of points is characterised by a plurality of features comprising at least a Doppler velocity measurement indicative of the velocity of the point and an angle-of-arrival measurement indicative of the angle to the point from a reference direction of the radar apparatus;
using a first neural network comprising a shared-multilayer-perceptron, SMLP, encoder, for each point of the radar-point-cloud information, mapping the features thereof to a greater number of mapped-features to provide mapped-radar-point-cloud information;
using a second neural network comprising an average pooling layer, receiving the mapped-radar-point-cloud information and, based on thereon, determining a global feature vector indicative of one or more characteristics of the mapped-radar-point-cloud information;
generating a feature matrix representing each of the points, wherein each point therein is characterized by a feature-set based on a combination of:
i) the features from the radar-point-cloud information,
ii) the mapped-features from the mapped-radar-point-cloud information and
iii) the global feature vector; and using a further neural network and determining, for each point,
i) a pointwise-weight representing a likelihood that the point represents a stationary object in the space rather than a moving object in the space;
ii) a pointwise-offset comprising a correction to be applied to the Doppler velocity measurement to at least reduce the Doppler velocity measurement for points having a greater than expected Doppler velocity; and
providing an estimate of the motion of the radar apparatus indicative of at least two-dimensional motion based on the pointwise weight and the pointwise offset and the Doppler velocity measurements of the radar-point-cloud information.

In one or more embodiments, the method includes training the one or more neural network models based on training data, comprising instances of point-cloud information associated with a respective predetermined, motion value, and a loss function, the loss function comprising a function of:
a) a motion loss function, Lossₘₒₜᵢₒₙ, based on a mean squared error between the estimate of the motion of the radar apparatus and the predetermined, motion value; and
b) a Doppler loss function, Loss_{doppler}, based on a transform of the real, predetermined, motion value to a radial velocity, a Doppler error comprising a difference between the transform of the predetermined, motion value and the Doppler velocity measurements of each instance of the training data, a probability that the Doppler error is expected relative to a sample distribution, and a mean squared error function.

In one or more embodiments, the loss function is further based on:
c) a sample weight function, S, comprising a measure of whether the distribution of the Doppler velocity measurements of each set of the training data is consistent with an expected sample distribution based on the real, predetermined, motion value.

In one or more embodiments, the processing of the radar-point-cloud information using one or more neural network models comprises processing by a deep neural network.

According to a third aspect of the present disclosure there is provided vehicle including the apparatus of the first aspect and a radar apparatus configured to provide the radar-point-cloud information to the apparatus.

While the disclosure is amenable to various modifications and alternative forms, specifics thereof have been shown by way of example in the drawings and will be described in detail. It should be understood, however, that other embodiments, beyond the particular embodiments described, are possible as well. All modifications, equivalents, and alternative embodiments falling within the spirit and scope of the appended claims are covered as well.

The above discussion is not intended to represent every example embodiment or every implementation within the scope of the current or future Claim sets. The figures and Detailed Description that follow also exemplify various example embodiments. Various example embodiments may be more completely understood in consideration of the following Detailed Description in connection with the accompanying Drawings.

### BRIEF DESCRIPTION OF THE DRAWINGS

One or more embodiments will now be described by way of example only with reference to the accompanying drawings in which:

FIG. 1 shows an example embodiment of an apparatus for determining ego-motion and a radar apparatus;

FIG. 2 shows an example hardware implementation of the apparatus;

FIG. 3 shows an example functional block diagram illustrating the processing the apparatus is configured and/or trained to perform; and

FIG. 4 shows a flowchart illustrating an example method of operation.

### DETAILED DESCRIPTION

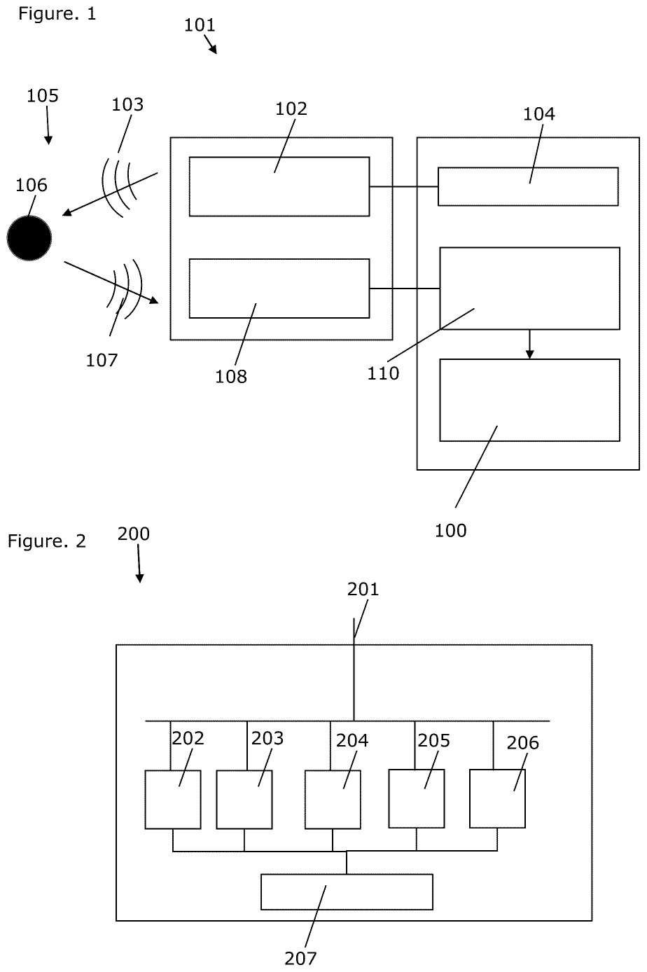

FIG. 1 shows an apparatus 100 for determining the ego-motion of a radar apparatus 101. The apparatus 100 may comprise one or more processors configured to process the output of the radar apparatus 101.

In FIG. 1, the apparatus 100 is shown as part of the processing functions of the radar apparatus 101. Accordingly, one or more processors of the radar apparatus 101 may provide the functionality of the apparatus 100. However, in other examples, the apparatus 100 may be separate from the radar apparatus 101 or the processor(s) that provide radar signal processing functionality for the radar apparatus 101.

In general, the radar apparatus 101 comprises a transmit path 102 for generation of radar signals 103 under the control of a radar controller 104. As will be understood, the radar signals are transmitted into a space 105 typically comprising one or more objects 106 (one shown) and reflected radar signals 107 are received by the radar apparatus 101 and, in particular, by a receive path 108 thereof.

The received, reflected radar signals 107 are processed by signal processor 110 to generate radar-point-cloud information comprising a plurality of points. The points thereby represent points in the space 105 where objects 106 have been detected. Thus, the plurality of points are indicative of one or more objects 106 in the space 105 at a single time point. Subsequent instances of the radar-point-cloud information may represent later time points. Each point of the plurality of points is characterised by a plurality of features comprising at least a Doppler velocity measurement indicative of the velocity of the point and an angle-of-arrival measurement indicative of the angle to the point from a reference direction of the radar apparatus 101 (such as the direction the transmitter/receiver of the radar apparatus 101 faces).

The radar apparatus 101 may comprise a mm-Wave radar apparatus.

In one or more examples, the plurality of features that characterise each point may additionally include: three spatial dimension coordinates (e.g. cartesian coordinates), the angle-of-arrival measurement comprising azimuth and elevation (available, if the radar apparatus has a planar antenna array), a range distance between the radar apparatus and the point, and/or a reflected signal power measurement in addition to the Doppler measurement and the angle-of-arrival measurement. Additionally, there may be other learnt feature extractors, e.g. values that describe each point or groups of points, which can be concatenated with the point-cloud information.

In the examples that follow, the angle-of-arrival measurement may be assumed to be an azimuth angle. However, in other examples, the angle-of-arrival measurement may comprise an azimuth and an altitude angle-of-arrival measurement.

The apparatus 100 is configured to process each frame of radar-point-cloud information from the radar apparatus 101. In the embodiments that follow, the apparatus 100 can operate solely on single frames of the radar-point-cloud information without additional input from other motion sensors.

The radar-point-cloud information does not include the motion state of the objects 106, that is whether the object of which the point forms part is stationary or moving. If the object is moving, it may be advantageous to determine the velocity vector of the object, the velocity magnitude, or at least whether the object is moving in the same direction or the opposite direction of the radar apparatus 101 or the vehicle to which the radar apparatus 101 may be mounted. Such information may be important to the autonomous driving functions or the advanced driver assistance systems.

In order to determine whether a point or object of which the point may be part is moving or stationary requires information on whether the radar apparatus 101 is moving, that is the radar apparatus's own ground velocity (i.e. relative to ground) or ego-velocity, as it is known in the art.

It may be possible to determine the ground velocity or ego-velocity by reference to external sensors, such as GPS or an inertial measurement unit. However, it may be desirable to determine the ego-motion of the radar apparatus 101 solely from the radar-point-cloud information. Thus, if other sensors or data links become unreliable, radar-based perception of the ego-motion may still function correctly. The present embodiments relate to determining the ego-motion of the radar apparatus 101 solely from individual instances of the radar-point-cloud information.

FIG. 2 shows an example apparatus 200, which may be a hardware implementation of the apparatus 100. The apparatus 200 may comprise an ASIC or other circuitry suitable for neural network processing. The ASIC may include an input 201 for receiving the radar-point-cloud information. A plurality of processing elements 202-206 may provide for point-wise processing of the points of the radar-point-cloud information, as will be described below. The processing elements may comprise General Matrix-Matrix Multiply (GEMM) devices and activation machines. A vector sum machine 207 may receive the output of the processing elements 202-206 to output the estimate of the ego-motion.

Thus, generally, the proposed apparatus 200 may comprise an inferencing machine and may be configured to implement a deep neural network for radar-based ego motion estimation. The implementation 200 comprises one or more deep neural network accelerators containing GEMM machines for providing multilayer perceptron(s) (with the activation machine for non linear activation), along with a vector sum machine for the global feature extraction.

The following description provides an example use-case in which the radar apparatus 101 is mounted to a vehicle. Accordingly, in one or more examples, the radar apparatus 101 may comprise an automotive radar for use as part of an autonomous driving system or an advanced driver assistance system.

The radar-point-cloud information may be considered as a multi-dimensional radar point cloud matrix PXM, where J is the number of detected points, n is the radar index comprising a designator of the radar apparatus 101, and M is the number of features that characterize each point of the cloud. For simplicity, we will only consider one radar apparatus and therefore n=1 in this example description.

For the vehicle to which the radar apparatus 101 is mounted, designated “c”, the direction of the x-axis may be configured to coincide with the down-range motion of the vehicle, and the direction of the y-axis may be configured to coincide with the cross-range motion of the vehicle. Therefore, the vehicle's 2D motion state can be described as

$${e}_{c} = \{ {v}_{x}^{c} , {v}_{y}^{c} , {ω}^{c} \} where {v}_{x}^{c}$$

is the down-range velocity,

$${v}_{y}^{c}$$

is the cross-range velocity, and ω^{c} is the rotational velocity.

It can be predetermined that the radar apparatus 101 is mounted at the position

$$\{ {x}_{n}^{c} , {y}_{n}^{c} , {θ}_{n}^{c} \} where {x}_{n}^{c}$$

is the distance to the x-axis,

$${y}_{n}^{c}$$

is the distance to the y-axis, and

$${θ}_{n}^{c}$$

is the mounting angle of the radar apparatus 101 relative to the vehicle's x-axis. Since the radar apparatus 101 measures the relative motion between itself and the detected object 106, it is reasonable to transform the ego-motion from the vehicle's coordinate system to the radar apparatus's coordinate system.

For the radar's coordinate system, it is usually assumed that the direction of the x-axis coincides with the boresight direction of the radar apparatus 101. Then, the 2D motion state of the radar apparatus 101 can be expressed as

$${e}_{n} = \{ {v}_{x}^{n} , {v}_{y}^{n} , {ω}^{n} \} .$$

it is important to note that ωⁿ=ω^{c}, since all points on a rigid vehicle body will experience the same angular velocity. Finally, the transformation between the motion states e_{c} and eₙ can be expressed as:

$$[ \begin{matrix}{v}_{x}^{n} \\ {v}_{y}^{n} \\ {ω}^{n}\end{matrix} ] = [ \begin{matrix}cos {θ}_{n}^{c} & sin {θ}_{n}^{c} & 0 \\ - sin {θ}_{n}^{c} & cos {θ}_{n}^{c} & 0 \\ 0 & 0 & 1\end{matrix} ] [ \begin{matrix}1 & 0 & - {y}_{n}^{c} \\ 0 & 1 & {x}_{n}^{c} \\ 0 & 0 & 1\end{matrix} ] [ \begin{matrix}{v}_{x}^{c} \\ {v}_{y}^{c} \\ {ω}^{c}\end{matrix} ] \qquad ( 1 )$$

For the radar-point-cloud information represented as a radar point cloud matrix

$${P}_{n}^{J \times M} ,$$

the Doppler velocity measurement (d) and the angle-of-arrival measurement (a) of the j-th detection point pⱼ in the radar-point-cloud information can be expressed as

$${p}_{j} = \{ {d}_{j}^{n} , {α}_{j}^{n} \} .$$

Please note that for simplicity, the angle-of-arrival measurement (a) for this discussion only comprises an azimuth angle, but a similar derivation can also be made if elevation angle is added. Since the Doppler velocity measurement represents the radial component of the relative motion between the radar apparatus 101 and the detected object 106, assuming all J detection points are from stationary objects, the relationship between the radar apparatus 101 motion state and the Doppler velocity measurements can be expressed as:

$$[ \begin{matrix}{d}_{j = 1}^{n} \\ {d}_{j = 2}^{n} \\ ⋮ \\ {d}_{j = J}^{n}\end{matrix} ] = - [ \begin{matrix}cos {α}_{1}^{c} & sin {α}_{1}^{c} \\ cos {α}_{2}^{c} & sin {α}_{2}^{c} \\ ⋮ & ⋮ \\ cos {α}_{J}^{c} & sin {α}_{J}^{c}\end{matrix} ] [ \begin{matrix}{v}_{x}^{n} \\ {v}_{y}^{n}\end{matrix} ] \qquad ( 2 )$$

For simplicity, the vector of all Doppler velocity measurements is denoted as D, the negative of the radial velocity projection matrix is denoted as A, and the vector of

$${v}_{x}^{n} and {v}_{y}^{n}$$

is denoted as V. Then Equation 2 can be re-written as:

$$\begin{matrix}D = A . V \\ Wherein A = - [ \begin{matrix}cos {α}_{1}^{c} & sin {α}_{1}^{c} \\ cos {α}_{2}^{c} & sin {α}_{2}^{c} \\ ⋮ & ⋮ \\ cos {α}_{J}^{c} & sin {α}_{J}^{c}\end{matrix} ]\end{matrix}$$

Based on the above equation, two conclusions can be drawn. First, given at least two independent detection points (J≥2), it is possible to estimate

$${v}_{x}^{n} and {v}_{y}^{n} ,$$

using standard regression approaches such as the least square method as:

$${V}^{est} = {( {A}^{T} . A )}^{- 1} {A}^{T} D$$

Therefore, with the estimates of

$${v}_{x}^{n} and {v}_{y}^{n} ,$$

and the radar apparatus 101 position

$$\{ {x}_{n}^{c} , {y}_{n}^{c} , {θ}_{n}^{c} \}$$

relative to the vehicle, the ego-motion of the vehicle can be calculated by rearranging Equation 1 as shown below:

$${v}_{x}^{c} = {v}_{x}^{n} cos ( {θ}_{n}^{c} ) - {v}_{y}^{n} sin ( {θ}_{n}^{c} ) + {ω}^{c} {y}_{n}^{c} \qquad ( 3 )$$

$${ω}^{c} = \frac{{v}_{y}^{n} cos ( {θ}_{n}^{c} ) - {v}_{x}^{n} sin ( {θ}_{n}^{c} )}{{x}_{n}^{c}} \qquad ( 4 )$$

For each frame t of the radar-point-cloud information (wherein a frame represents the points from a single point in time), the global position of the radar apparatus 101 can be estimated using the relative motion estimates of the current frame and the global position of the previous frame. In the description that follows, we will describe an embodiment of the disclosure for obtaining

$${v}_{x}^{n} and {v}_{y}^{n} .$$

The apparatus 100, 200 is configured for determining the ego-motion of the radar apparatus 101 and therefore, in one or more examples, the ego-motion of the vehicle (or more generally the “platform”) to which the radar apparatus 101 is mounted.

In one or more embodiments, the functionality of the apparatus 100 is provided by a neural network, such as a deep neural network. The deep neural network may be formed of a plurality of layers, wherein the plurality of layers are provided by one or more further neural networks. In one or more embodiments, processing of the output from or the input to the deep neural network, DNN, or any one of the further, component, neural networks thereof may be provided by conventional processing based on defined functions or by an appropriately trained neural network.

In general, the apparatus 100 comprises one or more processors, which may be general purpose processors or ASICs that are configured to provide the functionality as described below. The ASIC may comprise a plurality of processing elements to process the radar-point-cloud information in parallel. In one or more other examples, the one or more processors may comprise a single processor or a parallel processing apparatus. It will be appreciated that other means for implementing the processing required by a neural network may be used.

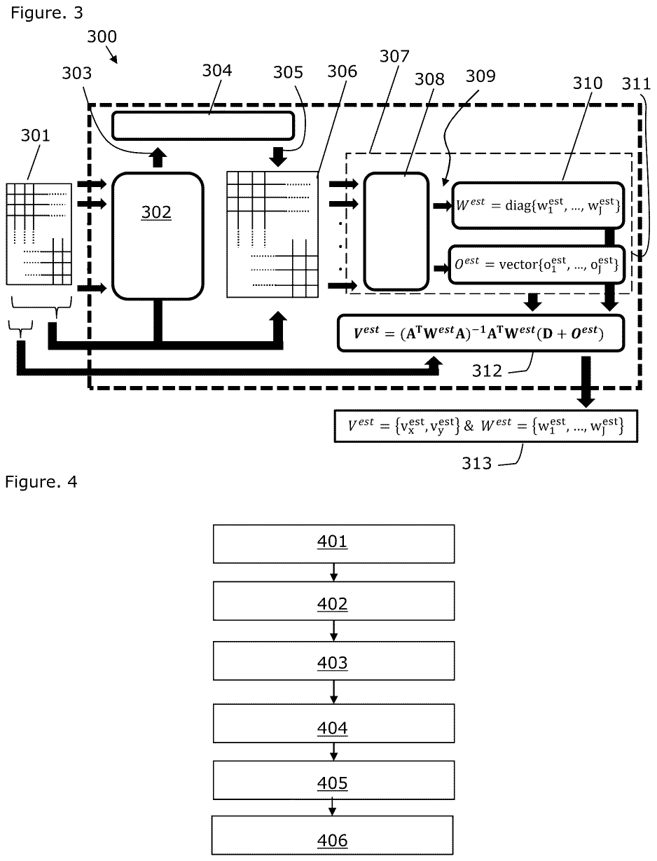

With reference to FIG. 3, which shows a functional block diagram of an apparatus 300, which may represent the functions of the apparatus 100. The radar-point-cloud information 301 is received by the apparatus 100. The radar-point-cloud information 301 is represented by a matrix of J rows, representing each point of the point cloud, and M columns, containing values of the M features that characterize each of the points, as mentioned above.

The apparatus 100, 300, is configured such that the radar-point-cloud information 301 is received by a first neural network 302, which acts as an encoder. The first neural network may comprise a shared-multilayer-perceptron, SMLP, trained such that for each point of the radar-point-cloud information, it provides a mapping of the features thereof to a greater number of mapped-features. Thus, the first neural network is configured to encode the features point-wise and project each of them onto a high-dimensional feature space. The output comprises mapped-radar-point-cloud information, which is provided at output 303.

The mapped-radar-point-cloud information is provided to a second neural network 304. The second neural network 304 may be provided as one or more layers of the DNN. The second neural network 304 comprises an average pooling layer which is trained to provide global feature extraction, that is identification of features that are present over all or some of the points rather than processing the mapped-radar-point-cloud information point-wise.

Thus, the second neural network 304 receives the mapped-radar-point-cloud information and, based on thereon, is trained to determine a global feature vector indicative of one or more characteristics of the mapped-radar-point-cloud information.

In one or more examples, the average pooling layer may be configured to provide a symmetric function and trained to aggregate information from all of the points of the mapped-radar-point-cloud information and output a global feature vector indicative of a characteristic(s) of the mapped-radar-point-cloud information. In this way, the global feature vector can provide a signature of all or at least a plurality of points of the mapped-radar-point-cloud information based on the training of the second neural network 304.

Next, a concatenation element 305, which may be provided by a neural network or be hard coded may receive the global feature vector, the mapped-radar-point-cloud information and the radar-point-cloud information. Thus, the concatenation element 305 is configured to generate a feature matrix 306 representing each of the points J, wherein each point therein is characterized by a feature-set based on a concatenated combination of:
i) the features from the radar-point-cloud information,
ii) the mapped-features from the mapped-radar-point-cloud information and
iii) the global feature vector.

In one or more examples the generation of the feature matrix 306 may comprise the concatenation element 305 being configured to duplicate the global feature vector J times (equal to the number of points) and, for each point, a concatenation of the features, the mapped features and one of the duplicated feature vectors may be generated, to thereby generate the feature matrix 306.

The output feature matrix 306 is a J×F pointwise feature matrix, wherein F represents the number of concatenated features wherein F is typically greater than M. The inventors have found that this mixture of point-wise determined “local” features and global features represented by the global feature vector may provide improved accuracy of the pointwise weight and pointwise offset described later.

The apparatus 100, 300 is further configured such that the feature matrix 306 is received by a further neural network 307.

The further neural network 307 is trained such that, for each point, there is provided:
i) a pointwise-weight representing a likelihood that the point represents a stationary object in the space 105 rather than a moving object in the space;
ii) a pointwise-offset comprising a correction to be applied to the Doppler velocity measurement to at least reduce the Doppler velocity measurement for points having a greater than expected Doppler velocity.

The further neural network 307 may be further trained to provide an estimate of the motion

$${v}_{x}^{n} , {v}_{y}^{n}$$

of the radar apparatus 101 indicative of at least two-dimensional motion based on the pointwise weight and the pointwise offset.

Thus, the DNN provides for the weighting of points, wherein the determined weights represent probabilities that the points represent stationary objects and thus from which an improved estimate of the ego motion can be made.

The further neural network 307 may comprise one or more component neural networks, such as a second shared-multilayer-perceptron, SMLP, configured to act as a decoder and two or more estimators.

In one or more examples, the further neural network 307 comprises a third neural network 308 (sometimes referred to herein as “the second shared-multi-layer-perceptron 308”) comprising a second shared-multilayer-perceptron, SMLP, decoder, configured to receive the feature matrix 306 and is trained to, for each point of the feature matrix 306, map the feature-set of F features to a lesser number of “mapped-features”. Thus, the output 309 is a mapped-feature matrix comprising a matrix of J points by F₂ features, wherein F₂ represents the lesser number of “mapped-features”.

Thus, in summary, the second shared-multilayer-perceptron 308 decodes the local and global features of the feature matrix 306 in a point-wise manner and transforms them into a lower-dimensional feature space.

The lower dimension mapped-feature matrix may then be provided to the prediction elements or “heads” which comprise:
(a) a pointwise-weights prediction element 310 trained to, based on the mapped-feature matrix, provide the pointwise weight; and
(b) a pointwise-offset prediction element 311 trained to, based on the mapped-feature matrix, provide the pointwise offset.

In one or more examples, the pointwise-weights prediction element 310 (sometimes referred to herein as “the neural network 310”) comprises a neural network or layers of the DNN configured to operate based on a weighted least squares algorithm.

In one or more examples, the pointwise-weights prediction element 310 comprises a neural network configured to operate based on a weighted least squares algorithm. The neural network may be trained to directly scale down large fitting errors caused by outliers. As will be understood by those skilled in the art, outliers are observed data points that are far from (i.e. above a threshold from) the least squares line. In the context of radar-based information, outliers may be, for example, moving objects, false alarms, or multi-path reflections, that do not follow the relative motion of the radar apparatus (i.e. do not follow equation 2 given their AoA measurements).

The neural network 310 may comprise a fully connected layer with a single output neuron. As will be understood by those skilled in the art, the fully-connected single-neuron layer is used to convert the output of the second shared-multilayer-perceptron 308 (acting as a decoder) into a single number between 0 and 1 (weight) for each point (i.e. point-wise weight). In one or more examples, the pointwise-weights prediction element is trained to determine the pointwise-weights based on a sigmoid activation function, which provides the single number weight as described. In one or more examples, the pointwise-weights prediction element is provided by layers of the DNN.

Turning to the pointwise-offset prediction element 311, prior to weighted least squares processing by the pointwise-weights prediction element 310, the pointwise-offset prediction element 311 is trained such that the Doppler velocity measurements of the radar-point-cloud information 301 are shifted by the predicted pointwise offset. In this way, errors caused by the ‘distant’ outliers, which have Doppler velocity measurements far from expected, will be reduced. Moreover, the DNN has been found to be more robust and less sensitive to the weights of these distant outliers when trained to provide the pointwise-offset values.

In one or more examples, the pointwise-offset prediction element 311 comprises a neural network comprising a fully connected layer with a single output neuron. The fully-connected single-neuron layer may use a linear activation function which outputs a single number that is proportional to the input (unbounded output value) for each point. In one or more examples, the pointwise-offset prediction element is configured to determine the pointwise-weights without a sigmoid activation function. In one or more examples, the pointwise-offset prediction element is provided by layers of the DNN.

The DNN is further trained or configured to provide an estimate 313 of the motion

$${v}_{x}^{n} , {v}_{y}^{n}$$

of the radar apparatus 101 indicative of at least two-dimensional motion based on the pointwise weight and the pointwise offset and the Doppler velocity measurements of the radar-point-cloud information 301.

In one or more examples, an output node 312 determines the estimate of the motion of the radar apparatus 101, V^{est} based on:

$${V}^{est} = {( {A}^{T} {W}^{est} . A )}^{- 1} {A}^{T} {W}^{est} ( D + {0}^{est} )$$

wherein A comprises a matrix that transforms Doppler velocity measurements to cartesian velocity measurements (named the radial velocity projection matrix, A above), W^{est} is a matrix of the pointwise weights, O^{est} is a matrix of the pointwise offsets and D is a matrix of the Doppler velocity measurements for each of the points, extracted from the radar-point-cloud information.

In one or more examples, the ego-motion of the radar appartus 101, V^{est} may be translated to the ego-motion of the vehicle to which it is mounted.

Thus, the translational and rotational velocities of the “ego-vehicle” can be quickly determined according to Equations 3 and 4 above.

As a further output, the apparatus 300 may be configured to provide an output identifying one or more objects 106 in the space 105 as comprising one of a stationary object and a moving object based on the pointwise weight and the pointwise offset. Thus, the points may be spatially grouped based on their proximity to one another and their pointwise weight and their pointwise offset, such as by a clustering algorithm. Thus, objects in the space 105 can be identified and assigned as being stationary or moving based on the pointwise weight relative to a threshold and, optionally, the pointwise offset relative to a further threshold. Alternatively, a classifying algorithm or trained neural network model may be used.

The apparatus 100, 300 may be trained using training data wherein each instance of training data is associated with a real, predetermined, motion value for the radar apparatus 101. That is the measured motion of the radar apparatus 101 and/or vehicle when the instance of training data was captured.

The training of the DNN of the apparatus 100 may be performed, as will be appreciated by those skilled in the art, based on the provision of the instances of training data, the real, predetermined, motion values associated with each instance and the following loss function.

The loss function comprises a function of:
a) a motion loss function, Lossₘₒₜᵢₒₙ, based on a mean squared error between the estimate of the motion of the radar apparatus and a real, predetermined, motion value; and
b) a Doppler loss function, Loss_{doppler}, based on a transform of the real, predetermined, motion value to a radial velocity, a Doppler error comprising a difference between the transform of the real, predetermined, motion value and the Doppler velocity measurements of each set of the training data, a probability that the Doppler error is expected relative to a sample distribution, and a mean squared error function.

In particular, the motion loss function may use the mean squared error (MSE) to measure how close the estimated motion V^{est} is to the real, predetermined, motion value, termed the ground truth V^{gt}. Specifically, it can be expressed as follows:

$${Loss}_{motion} = \frac{1}{B} {\sum }_{b = 1}^{B} {( {V}_{b}^{gt} - {V}_{b}^{est} )}^{2}$$

Where B is the batch size and b comprises an index for stepping through the batch. The batch size is a parameter used during model training. For example, the total number of training examples (point clouds) is divided into groups with each group having B point clouds. Then, the loss function is calculated based on the model performance over B predictions. In other examples, the batch size may represent all of the training examples.

While the motion loss drives the predictions made by the apparatus 100, 300 as close as possible to the ground truth, it may be less effective at explicitly training the DNN as to which points are outliers and should be assigned smaller weights during the determination of the pointwise weights.

It has been found that in some embodiments, training using only the motion loss function leads the resultant model to overfit at a few points, while ignoring many inlier points.

This can make the weighted least squares process performed by the pointwise-weights prediction element highly dependent on the accuracy of finding key points and can lead to performance degradation when it incorrectly flags an outlier as an inlier. The Doppler loss function has been found to be advantageous for training the apparatus or DNN thereof. It has been found to guide the neural network or DNN to locate key points that originated from static objects thereby improving the ego-motion determination.

To address this issue, the Doppler loss function may mitigate the impact of outliers. In particular, the Doppler loss function may use the ground-truth ego-motion V^{gt} to calculate the discrepancy between the expected and measured Doppler velocities for each point. An adjusted Doppler velocity measurement may then be used by the pointwise weight prediction element in determination of the matrix of the pointwise weights, W^{est}

As explained above, given the ground-truth ego-motion V^{gt} and the radial velocity projection matrix A, the expected measurements of Doppler velocities can be written as:

$${D}^{exp} = A . {V}^{gt}$$

Then, a Doppler error measurement (D^{error}) between expected and measured Doppler velocity measurements for the points is calculated as follows:

$${D}^{error} = {D}^{exp} - D$$

Ideally, D^{error} should be a zero vector, if all J points are originated from stationary objects 106 and the Doppler velocity measurements and the angle-of-arrival measurements and ground-truth ego-motion are noise-free.

However, as can be appreciated, this is not true in real-life scenarios. In order to locate the outliers, it may be postulated that the Doppler error follows a Gaussian distribution with a mean of zero. Therefore, the pointwise likelihood, W^{gt}, that Doppler velocity measurements for each points is an inlier can be expressed as:

$${W}^{gt} = \frac{1}{σ \sqrt{2 π}} exp ( - \frac{{( {D}^{error} - 0 )}^{2}}{2 {σ}^{2}} )$$

Wherein σ is a standard deviation of the gaussian distribution. It will be appreciated that the error in Doppler velocity measurement may be assumed to be Gaussian distributed in one or more examples, and therefore o is the standard deviation of the Gaussian distribution. It may be used as a tuning parameter but, in other examples, may also be determined by knowing the Doppler resolution and accuracy of the radar.

Given W^{est} and W^{gt}, the Doppler loss function may be as follows:

$${Loss}_{Doppler} = \frac{1}{B} {\sum }_{b = 1}^{B} {( {W}_{b}^{gt} - {W}_{b}^{est} )}^{2}$$

Where B is the batch size and b includes an index for stepping through the batch.

Thus, the Loss function may be given as:

$$Loss Function = ( {Loss}_{motion} + μ \cdot {Loss}_{doppler} )$$

Wherein μ is an empirically found weight value set during training.

In one or more further examples, the loss function is further based on:
c) a sample weight function, S, comprising a measure of whether the distribution of the Doppler velocity measurements of each set of the training data is consistent with an expected sample distribution based on the real, predetermined, motion value.

The inventors have determined that the effectiveness of the proposed loss function to the training has an underlying assumption that all Doppler measurements of detected stationary objects obey the equation D=A·V explained above.

However, this is not always the case. Therefore, in order to mitigate the effect of “bad” instances of the training data, the sample weight function is proposed to weight each instance of the training data individually. The sample weight function S is the sum of the pointwise likelihood wat, and, in one or more examples, may be expressed as follows:

$$S = \{ {S}_{1} , … , {S}_{B} \} = \{ {\sum }_{j = 1}^{J} ( {W}_{1 , j}^{gt} ) , … , {\sum }_{j = 1}^{J} ( {W}_{B , j}^{gt} ) \}$$

The proposed sample weight function is this configured to assign higher importance to instances of the training data that have more points that are consistent with expected Doppler velocity measurements (i.e. based on the ground truth). This has been found to significantly mitigate negative effects caused by, for example, radar-point-cloud information of the training data with only outliers, inaccurate ground-truth information, or non-zero lateral velocities and non-zero object heights (an attribute that specifies the height of the object in the real, 3D world to account for different Doppler measurements received from the same objection due to the object's height).

Thus, in this further example, the loss function may comprises:

$${Loss}_{Function} = ( {Loss}_{motion} + μ \cdot {Loss}_{doppler} ) \cdot S$$

wherein μ is the weighting factor.

The apparatus 100, 300, after training using the methodology defined above, was evaluated in terms of an absolute pose error which comprising the pose difference between the estimation and the true motion. It was also evaluated using a Relative Trajectory Error (RTE), which also measures the long-term stability of the trained apparatus 100, 300. It was found that the apparatus 100, 300 performed well and effectively mitigated the effects of non-stationary objects on the ego-motion estimations made.

We also disclose a method, with reference to FIG. 4, provided by one or more processors, the method comprising:
receiving 401 radar-point-cloud information, the radar-point-cloud information comprising a plurality of points determined by the radar apparatus indicative of one or more objects in a space at a single time point, wherein each point of the plurality of points is characterised by a plurality of features comprising at least a Doppler velocity measurement indicative of the velocity of the point and an angle-of-arrival measurement indicative of the angle to the point from a reference direction of the radar apparatus;
using 402 a first neural network comprising a shared-multilayer-perceptron, SMLP, encoder, for each point of the radar-point-cloud information, mapping the features thereof to a greater number of mapped-features to provide mapped-radar-point-cloud information;
using 403 a second neural network comprising an average pooling layer, receiving the mapped-radar-point-cloud information and, based on thereon, determining a global feature vector indicative of one or more characteristics of the mapped-radar-point-cloud information;
generating 404 a feature matrix representing each of the points, wherein each point therein is characterized by a feature-set based on a combination of:
   i) the features from the radar-point-cloud information,
   ii) the mapped-features from the mapped-radar-point-cloud information and
   iii) the global feature vector;
using 405 a further neural network and determining, for each point,
   i) a pointwise-weight representing a likelihood that the point represents a stationary object in the space rather than a moving object in the space;
   ii) a pointwise-offset comprising a correction to be applied to the Doppler velocity measurement to at least reduce the Doppler velocity measurement for points having a greater than expected Doppler velocity.
providing 406 an estimate of the motion

$${v}_{x}^{n} , {v}_{y}^{n}$$

of the radar apparatus indicative of at least two-dimensional motion based on the pointwise weight and the pointwise offset and the Doppler velocity measurements of the radar-point-cloud information.

The instructions and/or flowchart steps in the above figures can be executed in any order, unless a specific order is explicitly stated. Also, those skilled in the art will recognize that while one example set of instructions/method has been discussed, the material in this specification can be combined in a variety of ways to yield other examples as well, and are to be understood within a context provided by this detailed description.

In some example embodiments the set of instructions/method steps described above are implemented as functional and software instructions embodied as a set of executable instructions which are effected on a computer or machine which is programmed with and controlled by said executable instructions. Such instructions are loaded for execution on a processor (such as one or more CPUs). The term processor includes microprocessors, microcontrollers, processor modules or subsystems (including one or more microprocessors or microcontrollers), or other control or computing devices. A processor can refer to a single component or to plural components.

In other examples, the set of instructions/methods illustrated herein and data and instructions associated therewith are stored in respective storage devices, which are implemented as one or more non-transient machine or computer-readable or computer-usable storage media or mediums. Such computer-readable or computer usable storage medium or media is (are) considered to be part of an article (or article of manufacture). An article or article of manufacture can refer to any manufactured single component or multiple components. The non-transient machine or computer usable media or mediums as defined herein excludes signals, but such media or mediums may be capable of receiving and processing information from signals and/or other transient mediums.

Example embodiments of the material discussed in this specification can be implemented in whole or in part through network, computer, or data based devices and/or services. These may include cloud, internet, intranet, mobile, desktop, processor, look-up table, microcontroller, consumer equipment, infrastructure, or other enabling devices and services. As may be used herein and in the claims, the following non-exclusive definitions are provided.

In one example, one or more instructions or steps discussed herein are automated. The terms automated or automatically (and like variations thereof) mean controlled operation of an apparatus, system, and/or process using computers and/or mechanical/electrical devices without the necessity of human intervention, observation, effort and/or decision.

It will be appreciated that any components said to be coupled may be coupled or connected either directly or indirectly. In the case of indirect coupling, additional components may be located between the two components that are said to be coupled.

In this specification, example embodiments have been presented in terms of a selected set of details. However, a person of ordinary skill in the art would understand that many other example embodiments may be practiced which include a different selected set of these details. It is intended that the following claims cover all possible example embodiments.

1-15. (canceled)

16. An apparatus for determining ego-motion of a radar apparatus, the apparatus comprising one or more processors configured to:
receive radar-point-cloud information, the radar-point-cloud information comprising a plurality of points determined by the radar apparatus indicative of one or more objects in a space at a single time point, wherein each point of the plurality of points is characterized by a plurality of features comprising at least a Doppler velocity measurement indicative of the velocity of the point and an angle-of-arrival measurement indicative of the angle to the point from a reference direction of the radar apparatus;
provide for processing of the radar-point-cloud information, the processing comprising:
(1) for each point of the radar-point-cloud information, mapping the features thereof to a greater number of mapped-features to provide mapped-radar-point-cloud information using a first neural network comprising a shared-multilayer-perceptron, SMLP, encoder;
(2) receiving the mapped-radar-point-cloud information and, based on thereon, determining a global feature vector indicative of one or more characteristics of the mapped-radar-point-cloud information using a second neural network comprising an average pooling layer;
(3) generating a feature matrix representing each of the points, wherein each point therein is characterized by a feature-set based on a combination of:
i) the features from the radar-point-cloud information,
ii) the mapped-features from the mapped-radar-point-cloud information and
iii) the global feature vector;
(4) determining, using a further neural network, for each point,
i) a pointwise-weight representing a likelihood that the point represents a stationary object in the space rather than a moving object in the space; and
ii) a pointwise-offset comprising a correction to be applied to the Doppler velocity measurement to at least reduce the Doppler velocity measurement for points having a greater than expected Doppler velocity; and
(5) providing an estimate of the motion of the radar apparatus indicative of at least two-dimensional motion based on the pointwise-weight and the pointwise-offset and the Doppler velocity measurements of the radar-point-cloud information.

17. The apparatus of claim 16, wherein at least one of the first neural network, the second neural network, or the further neural network is trained based on training data, comprising instances of point-cloud information associated with a respective real predetermined motion value, and a loss function, the loss function comprising a function of:
a) a motion loss function, Lossₘₒₜᵢₒₙ, based on a mean squared error between the estimate of the motion of the radar apparatus and the real predetermined motion value; and
b) a Doppler loss function, Loss_{doppler}, based on a transform of the real predetermined motion value to a radial velocity, a Doppler error comprising a difference between the transform of the real predetermined motion value and the Doppler velocity measurements of each instance of the training data, a probability that the Doppler error is expected relative to a sample distribution, and a mean squared error function.

18. The apparatus of claim 17, wherein the loss function is further based on:
c) a sample weight function, S, comprising a measure of whether the distribution of the Doppler velocity measurements of each set of the training data is consistent with an expected sample distribution based on the real predetermined motion value.

19. The apparatus of claim 17, wherein the loss function comprises;
$$Loss Function = ( {Loss}_{motion} + μ \cdot {Loss}_{doppler} ) \cdot S$$
wherein μ is a weighting factor.

20. The apparatus of claim 16 wherein the processing of the radar-point-cloud information using one or more neural network models comprises processing by a deep neural network.

21. The apparatus of claim 16, wherein the average pooling layer is trained to provide a symmetric function configured to aggregate information from all of the points of the mapped-radar-point-cloud information and output the global feature vector indicative of a characteristic of the mapped-radar-point-cloud information.

22. The apparatus of claim 16, wherein the generation of the feature matrix is provided by a concatenation element, wherein the concatenation element is configured to duplicate the global feature vector a number of times equal to the number of points and, for each point, a concatenation of the features, the mapped features and one of the duplicated feature vectors is generated, to thereby generate the feature matrix.

23. The apparatus of claim 16, wherein the further neural network comprises:
a third neural network comprising a second shared-multilayer-perceptron, SMLP, decoder, configured to, for each point of the feature matrix, map the feature-set to a lesser number of mapped-features, to thereby provide mapped-feature matrix.

24. The apparatus of claim 23, wherein the further neural network comprises:
a pointwise-weights prediction element configured to, based on the mapped-feature matrix, provide the pointwise-weight.

25. The apparatus of claim 24, wherein the further neural network comprises:
a pointwise-offset prediction element configured to based on the mapped-feature matrix, provide the pointwise-offset.

26. The apparatus of claim 25, wherein the pointwise-weights prediction element comprises a neural network configured to operate based on a weighted least squares algorithm and a sigmoid activation function.

27. The apparatus of claim 25, wherein the pointwise-offset prediction element comprises a neural network.

28. The apparatus of claim 16, wherein the apparatus is configured to determine the estimate of the motion of the radar apparatus, V^{est} based on:
$${V}^{est} = ( {A}^{T} {W}^{est} \cdot A6 - 1 ) {A}^{T} {W}^{est} ( D + {O}^{est} )$$
wherein A comprises a matrix that transforms Doppler velocity measurements to cartesian velocity measurements, A^{T} represents a transpose of matrix A, W^{est} is a matrix of the pointwise-weights, O^{est} is a matrix of the pointwise-offsets and D is a matrix of the Doppler velocity measurements for each of the points extracted from the radar-point-cloud information.

29. The apparatus of claim 16, wherein the apparatus is configured to provide an output identifying one or more objects in the space as comprising one of a stationary object and a moving object based on the pointwise-weight and the pointwise-offset.

30. The apparatus of claim 18, wherein the sample weight function is configured to assign higher importance to the instances of training data that have more points that are consistent with expected Doppler velocity measurements based on the respective real predetermined motion value.

31. A method for determining ego-motion of a radar apparatus, the method performed by one or more processors and comprising:
receiving radar-point-cloud information, the radar-point-cloud information comprising a plurality of points determined by the radar apparatus indicative of one or more objects in a space at a single time point, wherein each point of the plurality of points is characterized by a plurality of features comprising at least a Doppler velocity measurement indicative of the velocity of the point and an angle-of-arrival measurement indicative of the angle to the point from a reference direction of the radar apparatus;
using a first neural network comprising a shared-multilayer-perceptron, SMLP, encoder, for each point of the radar-point-cloud information, mapping the features thereof to a greater number of mapped-features to provide mapped-radar-point-cloud information;
using a second neural network comprising an average pooling layer, receiving the mapped-radar-point-cloud information and, based on thereon, determining a global feature vector indicative of one or more characteristics of the mapped-radar-point-cloud information;
generating a feature matrix representing each of the points, wherein each point therein is characterized by a feature-set based on a combination of:
i) the features from the radar-point-cloud information, ii) the mapped-features from the mapped-radar-point-cloud information and
iii) the global feature vector; and
using a further neural network and determining, for each point,
i) a pointwise-weight representing a likelihood that the point represents a stationary object in the space rather than a moving object in the space;
ii) a pointwise-offset comprising a correction to be applied to the Doppler velocity measurement to at least reduce the Doppler velocity measurement for points having a greater than expected Doppler velocity; and
providing an estimate of the motion of the radar apparatus indicative of at least two-dimensional motion based on the pointwisc-weight and the pointwise-offset and the Doppler velocity measurements of the radar-point-cloud information.

32. The method of claim 31, wherein the method includes training the one or more neural network models based on training data, comprising instances of point-cloud information associated with a respective real predetermined motion value and a loss function, the loss function comprising a function of:
a) a motion loss function, Lossₘₒₜᵢₒₙ, based on a mean squared error between the estimate of the motion of the radar apparatus and the real predetermined motion value; and
b) a Doppler loss function, Loss_{doppler}, based on a transform of the real predetermined motion value to a radial velocity, a Doppler error comprising a difference between the transform of the real predetermined motion value and the Doppler velocity measurements of each instance of the training data, a probability that the Doppler error is expected relative to a sample distribution, and a mean squared error function.

33. The method of claim 32, wherein the loss function is further based on:
c) a sample weight function, S, comprising a measure of whether the distribution of the Doppler velocity measurements of each set of the training data is consistent with an expected sample distribution based on the real predetermined motion value.

34. The method of claim 31 wherein the processing of the radar-point-cloud information using one or more neural network models comprises processing by a deep neural network.

35. A vehicle including the apparatus of claim 16 and a radar apparatus configured to provide the radar-point-cloud information to the apparatus.
